(19) United States
(12) Patent Application Publication
(10) Pub. No.: US 2025/0023514 A1
(43) Pub. Date: Jan. 16, 2025

(54) SELF SUFFICIENT ENERGY SUPPLIED SYSTEM FOR GENERATING ATMOSPHERIC WATER AND METHOD TO CONTROL THE SYSTEM

(71) Applicant: Energy and Water Development Corp., Hamburg (DE)

(72) Inventors: Max Ralph HOFMEIER, Hamburg (DE); Irma VELAZQUEZ DIAZ, Hamburg (DE)

(73) Assignee: Energy and Water Development Corp., Hamburg (DE)

(21) Appl. No.: 18/688,661

(22) PCT Filed: Sep. 2, 2021
(86) PCT No.: PCT/EP2021/074299

§ 371 Date: Mar. 1, 2024

(51) Int. Cl. H02S 40/42; H02J 7/35; H02S 40/38

(52) U.S. Cl. CPC H02S 40/425; H02J 7/35; H02S 40/38

(57) ABSTRACT

A self-sufficient energy supplied system for generating atmospheric water includes an energy generation device, an atmospheric water generator, and an energy management application. The energy generation device includes a solar glass component having a solar cell layer that is electrically connectable to the energy storage device which is connectable to the atmospheric water generator. A method for controlling the system includes determining an energy output value of the energy generation device, connecting the solar cell layer with the management storage device via the energy management application if the energy output value is higher than a first value, connecting the solar cell layer via the energy management application with the energy storage device if the energy output value is higher than a second value, and connecting the energy storage device to the atmospheric water generation device via the energy management application if the energy output value is below the first value.

The invention relates to a system for generating atmospheric water while generating the required energy for its function and a method to control the system.

There are several techniques to generate water in dry regions or in regions in which a high amount of water is required. Commonly known are desalination devices close to the sea, which reduce the amount of salt in seawater to generate fresh water. Furthermore, water can directly be extracted from the atmosphere. An atmospheric water generator (AWG) is a device that extracts water from humid ambient air and converts it into water. Water vapor in the air can be extracted by condensation-cooling the air below its dew point, exposing the air to desiccants, or pressurizing the air.

There are two main challenges of these process: Energy consumption and large carbon footprint generated.

This atmospheric water generation uses cooling of air to collect condensed water. Those atmospheric water generators are commonly used in regions, which do not have a sufficient infrastructure to provide power required for the cooling of air. From WO 2020/170243 A1, an atmospheric water generator is known which is powered by electrical generators, which use diesel as energy source.

The present invention generally relates to a sustainable self-sufficient energy supplied Atmosphere water generation system (eAWG).

Thus, the technical object may be providing an improved system for generating atmospheric water and an improved method to control that system that are more efficient and that enable a higher amount of water generation than in the prior art, while securing the self-sufficient energy supply required, and preventing carbon footprint.

Claims 1 and 12 indicate the main features of the invention. Features of embodiments of the invention are subject of claims 2 to 11 and 12 to 13.

In an aspect of the invention, a system for generating atmospheric water is provided, the system comprising: at least one energy management system, at least one energy generation device, at least one energy storage device (like a battery), at least one software application; and at least one atmospheric water generator; wherein the at least one energy generation device comprises at least one solar glass component having at least one solar cell layer,; wherein the at least one solar cell layer is electrically connectable to the at least one atmospheric water generator, in particular via the energy storage device like a battery.

The invention provides a system, which uses solar energy as energy source for the atmospheric water generator. Thus, the energy generation device comprises at least one solar glass component having a solar cell layer. That solar cell layer may be connected to the battery and the battery may be connected to the atmospheric water generator. Since the solar energy is for free, the operational costs of the system are much lower than the costs of the prior art. Furthermore, the energy generation system may comprise a plurality of solar glass components each having a solar cell layer. The number of the solar glass components is not limited. All solar cell layers are connectable to the batteries depending on the electrical system configuration and the batteries are connectable to the atmospheric water generator. In operation of the system, the solar cell layers are connected to the batteries and the batteries are connectable to the water generation system. At night, the solar cell layer may for example be turn off from the electrical system configuration leaving the batteries be the energy source powering the atmospheric water generator. The energy output of the energy generation device may be much higher than the energy output of common diesel generators. In comparison to the prior art, the system has an integrated higher energy efficiency supply and is able to provide a higher atmospheric water generation rate.

In an example, the system may further comprise at least one energy storage device (battery), wherein the at least one solar cell layer is electrically connectable to the at least one energy storage device and this is electrically connectable to the at least one atmospheric water generator.

The solar cell layer may be connected to energy storage device, and this is electrically connectable to the atmospheric water. Particularly, if the energy generation device produces a higher amount of energy than required for operation the atmospheric water generation device, the excess of energy being produced may be stored in the energy storage device. Furthermore, if the solar glass component does not produce enough energy for the operation of the atmospheric water generation device, the energy storage system may provide energy to the atmospheric water generation system.

Preferably, the system may further comprise at least one energy management application, wherein the at least one solar cell layer, and the at least one energy storage device are electrically connected to the at least one atmospheric water generator.

Furthermore, the at least one energy management application may for example be configured to electrically connect the at least one solar cell layer and/or the at least one energy storage device to the at least one atmospheric water generator.

The energy management application may connect and disconnect the solar cell layer from energy storage device. Furthermore, the energy management system may connect and disconnect the energy storage device from the atmospheric water generator. Thus, the energy management application may control the energy source being used to drive the atmospheric water generation device. Furthermore, the energy management application may control the storing of the excess energy from the energy generation device.

The system may for example further comprise an energy output port.

If the energy storage device is at full capacity, any excess energy may be provided at the energy output port. Thus, the system for generating atmospheric water may also work as energy source for external systems. This further improves the efficiency of the system.

In another example, the at least one energy management device may be electrically connected to the energy output port and wherein the at least one energy management application is configured to connect the at least one solar cell layer to the energy output port.

The energy management application may control the energy flow between the components. The energy management application may further control whether the energy storage device can store further energy if the energy generation device produces excess energy. If the energy storage device cannot store any more energy, the energy management system may electrically connect the energy output port to the energy generation device to provide the excess energy to external systems.

Furthermore, the system may for example comprise a housing with a skeleton support structure, wherein the skeleton support structure comprises at least one diagonal strut being connected to the skeleton support structure with a first end section and a second end section, the at least one diagonal strut having a flat side surface extending between the first end section and the second end section.

The skeleton support structure provides a stable support for the housing and the system. The use of diagonal struts with a flat side surface for stabilizing the skeleton support structure improves the connectivity of flat panels.

The at least one solar glass component may for example be attached to the skeleton support structure, the at least one solar glass component forming a wall section of the housing.

The at least one solar glass component may form an outer wall of the housing.

Furthermore, the housing may for example have a pyramid shape or a castle shape.

The pyramid shape and the castle shape provide a plurality of outer surfaces, which may comprise solar glass components. Thus, the solar energy in the region around the system may be collected and used for the energy generation.

In another example, the system may comprise a plurality of solar glass components.

The plurality of solar glass components may for example cover most of or the complete outer surface of the system. Thus, the potential energy generation may be maximized.

In a further aspect, a method for controlling the system according to the above description is provided, the method having at least the following steps: Determining an energy output value of the energy generation device; Connecting the at least one solar cell layer with the at least one energy storage device via the energy management application if the energy output value is higher than a first threshold value; Connecting the at least one solar cell layer with the at least one energy storage device via the energy management application if the energy output value is higher than a second threshold value; Connecting the at least one energy storage device to the at least one atmospheric water generation device via the energy management application if the energy output value is below the first threshold value.

According to the method, the energy management system may work with threshold values to decide which components of the system are electrically activated to each other. The determined energy output value of the energy generation system is compared to a first threshold value. The method uses the first threshold value to decide, whether the energy generation device generates sufficient energy for the atmospheric water generator operation. If the energy generation device generates sufficient energy, the at least one solar cell layer may be deactivated, activating the one energy storage device. If not, the energy storage device is connected to the atmospheric water generator. This does not exclude connecting the solar cell layer to the atmospheric water generator, i.e. both, the at least one solar cell layer and the at least one energy storage device may be connected to the atmospheric water generator trough the energy management application. Furthermore, not all solar cell layers or energy storage device being present in the system are required to be connected to the atmospheric water generation if the system has more than one solar cell layer and/or more than one energy storage device. Thus, only some of entirety of solar cell layers and/or energy storage devices may be connected to the atmospheric water generator trough the energy management application. The second threshold value is used to assess whether the energy generation device generated excess energy that can be stored in the at least one energy storage device.

In an example, the method may further comprise the following steps: Determining a charge value of the energy storage device; Connecting the at least one solar cell layer with an energy output port via the energy management application if the charge value is higher than a third threshold value and if the energy output value is higher than the second threshold value.

According to the method, the third threshold value is used to decide whether the energy storage device can store further energy. If the energy storage device cannot store more energy, the excess energy may be provided at the energy output port.

In a further example, the method further may comprise the following step: Generating a cooling fluid with the at least one atmospheric water generation device; Cooling the at least energy storage device with the cooling fluid.

The cooling fluid may for example be the cooled air from which the atmospheric water was condensed. The cooled air that is produced in the atmospheric water generation process may further be used to cool the energy storage device. This further improves the efficiency of the system.

The effects and further embodiments of the method according to the present invention are analogous to the effects and embodiments of the system according to the description mentioned above. Thus, it is referred to the above description of the system.

Further features, details and advantages of the invention result from the wording of the claims as well as from the following description of exemplary embodiments based on the drawings. The figures show:

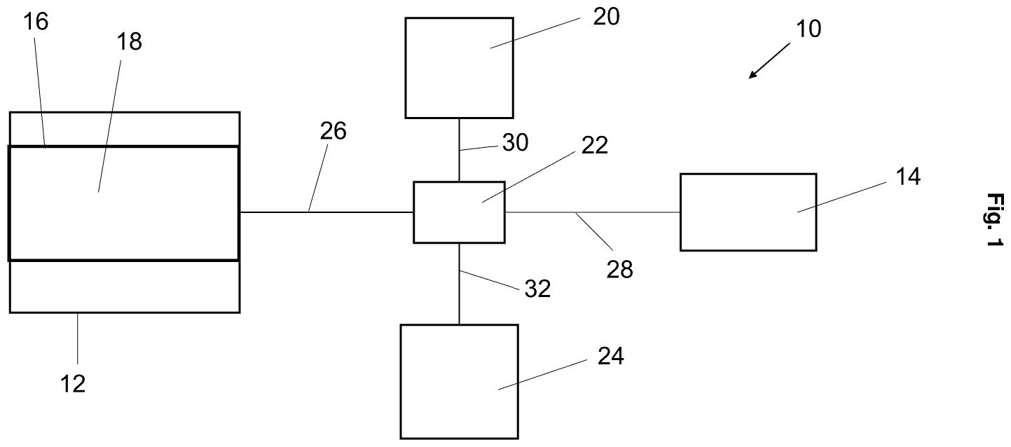

FIG. 1 a schematic drawing of the system for generating atmospheric water;

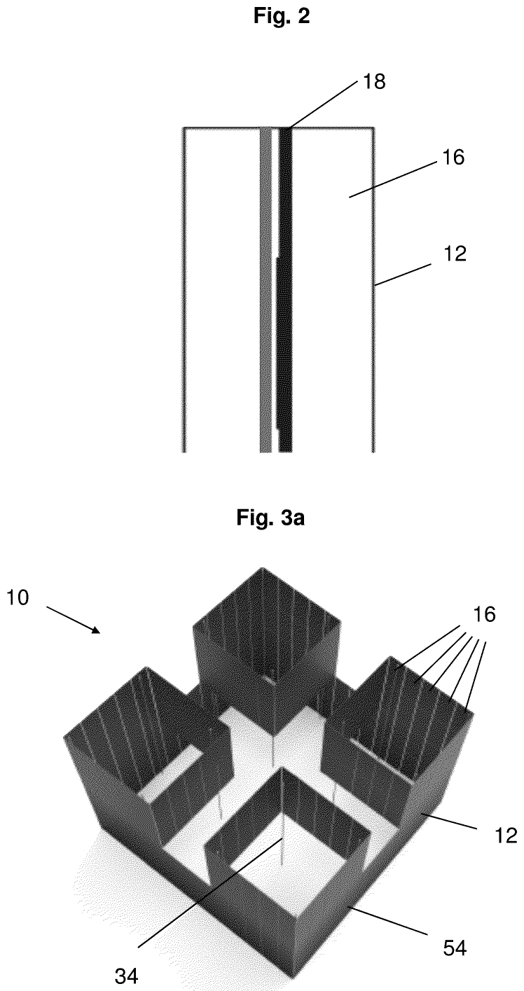

FIG. 2 a schematic drawing of a solar glass component;

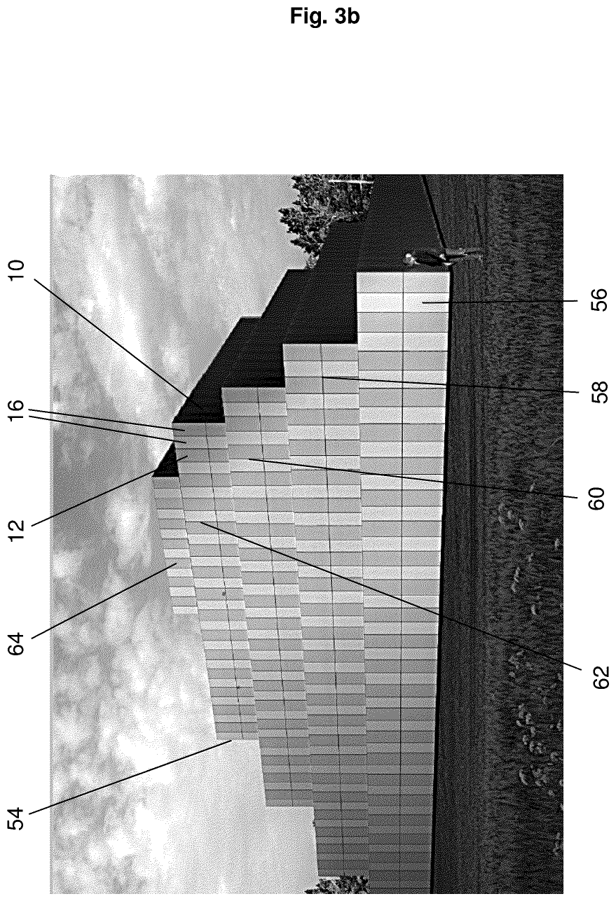

FIG. 3a, b a schematic drawing of examples of the system;

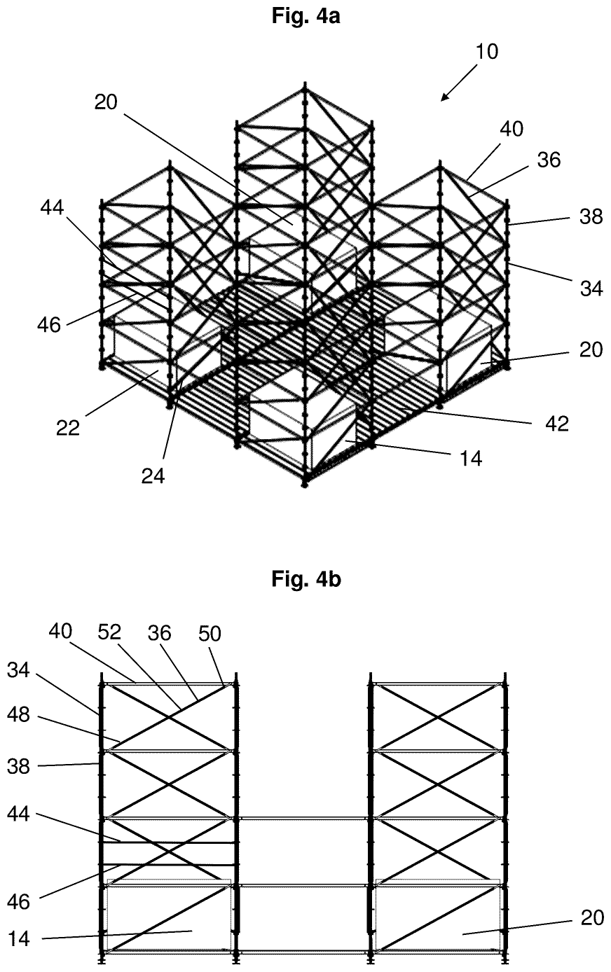

FIG. 4a-c a schematic drawing of a support structure of the system;

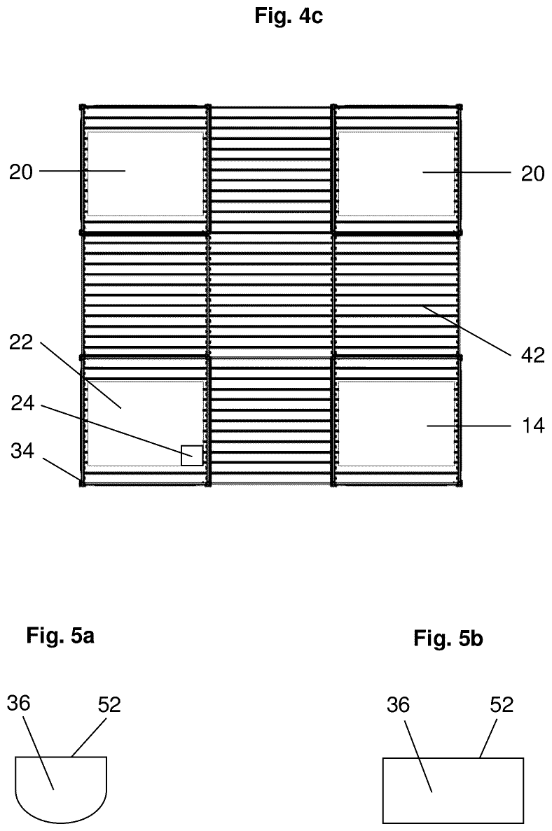

FIG. 5a, b a schematic cross-sectional drawing of a strut;

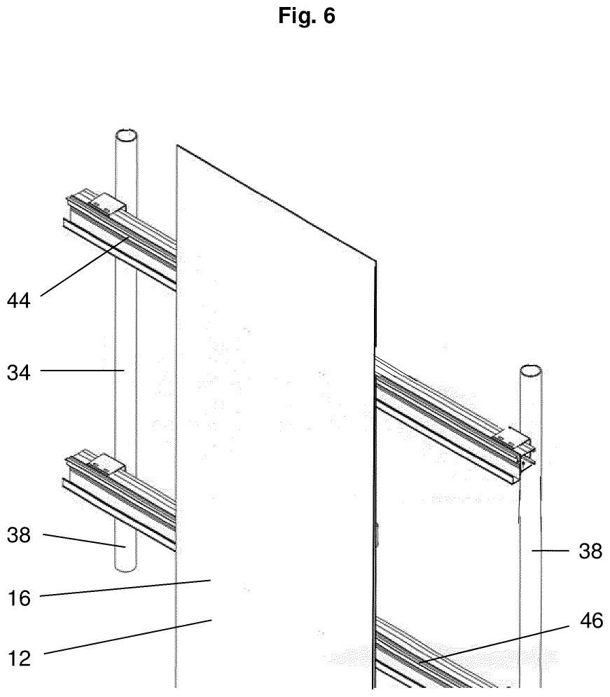

FIG. 6 a schematic drawing of the framework and a solar glass component with horizontal profiles; and

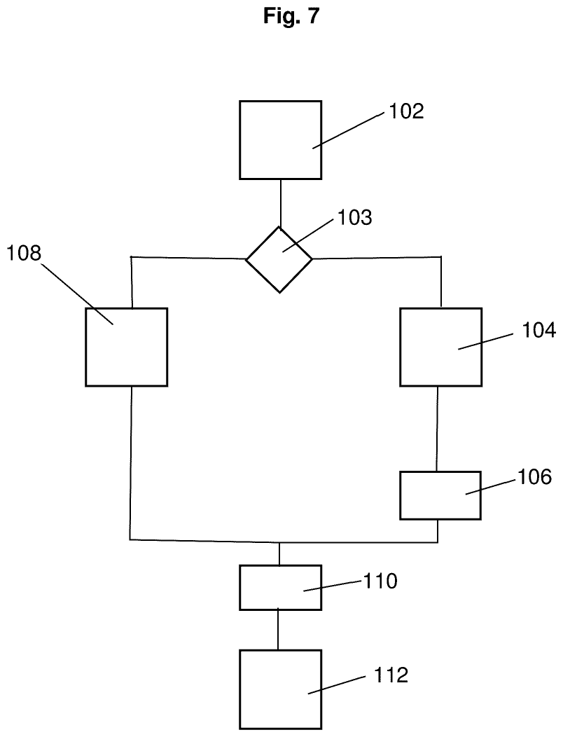

FIG. 7 a flow chart of the method for controlling the system.

FIG. 1 shows a schematic drawing of the system 10 for generating atmospheric water. The system comprises at least one energy generation device 12 and at least one atmospheric water generator 14. Furthermore, the system 10 may comprise at least one energy storage device 20, at least one energy management application 22 and at least one energy output port 24.

The at least one energy management application 22 is electrically connected to the at least one atmospheric water generator 14, the at least one energy storage device 20, the at least one energy management application 22 and at least one energy output port 24 via electrical line 26, 28, 30, 32.

Furthermore, the at least one energy management application 22 is configured to electrically connect and disconnect and disconnect those lines 26, 28, 30, 32. Thus, the energy management application 22 is configured to connect the atmospheric water generator 14 to the energy generation device 12 and/or the energy storage device 20, electrically, and to disconnect the atmospheric water generator 14 from the energy generation device 12 and/or the energy storage device 20.

The energy management application 22 is also configured to electrically connect the energy storage device 20 to the energy generation device 12 and/or to disconnect the energy storage device 20 from the energy generation device 12. Further, the energy management application 22 is also configured to connect the energy generation device 12 to the energy output port 24 and/or to disconnect the energy generation device 12 from the energy output port 24.

The energy generation device 12 has at least one solar glass component 16. The solar glass component 16 comprises a layered structure as shown in FIG. 2. At least one of the layers of the layered structure is a solar cell layer 18. The solar cell layer 18 is configured to generate electrical energy from light that falls on the solar cell layer 18. The electrical connection of the energy generation device 12 to one of the other components of the system 10 is performed by electrically connecting the solar cell layer 18 to those components. For example, the solar cell layer 18 is electrically connected to electrical line 26.

The energy generation device 12 may have a plurality of solar glass components 16.

FIG. 2 shows an exemplary embodiment of the system 10. The system 10 may have a housing 54 that is shaped as a castle. The housing 54 has wall elements wherein at least some of the wall elements are the solar glass components 16. Thus, the solar glass components 16 form a portion of the outer surface of the housing 54, i.e. the system 10.

The housing 54 may further comprise a support structure 34 for holding the solar glass components 16 of the energy generation device 12. The atmospheric water generator 14, the energy storage device 20 and the energy management device 22 may be arranged inside the housing 54.

The energy outlet port 24 may also be arranged inside the housing 54. Alternatively, the energy outlet port 24 may be arranged on a wall element of the housing 54. Furthermore, the energy outlet port 24 may be arranged outside the housing 54, wherein electrical line 32 extends from inside the housing 54 to outside the housing 54.

FIG. 3 shows another exemplary embodiment of the housing 54 that is shaped as a pyramid. The pyramid may have several levels 56-64. The housing 54 may only comprise the lowest level 56 if the energy output of only the lowest level 56 is sufficient. The levels 58-64 may be installed on a later stage to increase the energy output if required.

In that exemplary embodiment, the at least energy storage device 20 may be arranged inside the housing 54 in a region abutting the wall elements. For example, a row of a plurality of energy storage devices 20 may be arranged in parallel to a wall and right behind that wall.

The energy storage device 20 may for example be a lithium-iron-battery (Li—Fe-battery). However, the energy storage device 20 may also be a lithium ion battery, a lithium iron polonium battery, or another kind of energy storage. The energy storage device 20 may have a weight of 100 kg to 1000 kg, preferably, 200 kg to 500 kg, preferably around 400 kg.

The at least one atmospheric water generator 14 may condense water from the atmosphere by cooling down air. After condensing water from the cooled down air, the cooled air may be guides to the energy storage device 20 to cool the energy storage device 20.

A portion of the wall in the lowest level 56 may be a door structure, such that maintenance staff may enter the pyramid-like structure. In addition, a portion of the next level 58 above the door structure may also be a door structure, such that both door-structure provide a single door extending over two levels.

The support structure 34 may be a skeleton support structure made of a castle-shaped framework as shown in FIGS. 4a to 4c. FIG. 4a shows an isometric vie of the framework. FIG. 4b shows a side view and FIG. 4c shows a top view of the framework.

The atmospheric water generator 14, the energy storage device 20 and the energy management device 22 may be arranged below the tower-like structures of the framework as ballast for stabilizing the framework.

The framework may comprise vertical bars 38 and horizontal bars 40. Diagonal struts 36 connect to the vertical bars 38 and the horizontal bars 40 to stiffen the support structure 34. A first end section 48 and a second end section 50 of the diagonal struts 36 connect to the bars 38, 40, wherein the diagonal struts 36 extend between the end sections 48, 50.

The bottom if the housing 54 may comprise a floor 42 made from bars or profiles.

The roof (or top) of the housing may comprises a as well bars or profiles to hold the solar glass component. A façade may have for example five modules joints in width, to hold the roof (joint minimally small, slight angle of inclination of the modules).

The diagonal struts 36 may further comprise a flat side surface 52 extending between the first end section 48 and the second end section 50. FIGS. 5a and 5b show exemplary cross sections for the diagonal struts 36, wherein the cross sections extends transverse to the direction from the first end section 48 to the second end section 50.

The flat side surface 52 faces the solar glass component 16 that covers the diagonal strut 36.

The framework may further comprise horizontal profiles 44, 46 for hanging on the solar glass panels 16 as shown in FIG. 6. The horizontal profiles 44, 46 are attached to the vertical bars 38 of the support structure 34. Furthermore, those horizontal profiles 44, 46 may abut to the flat side surface 52. The framework may further comprise vertical profiles for holding on the solar glass panels 16.

FIG. 7 shows a flow chart of the method 100 for controlling the system for generating atmospheric water. Preferably, the system for generating atmospheric water has at least one energy generation device, at least one energy management application, at least one atmospheric water generator and at least one energy storage device.

In a first step 102, the energy output of the energy generation device is determined. An energy output value comprises the information about the determined energy output.

The energy output value is compared 103 to a first threshold value to assess whether the energy generation device produces enough energy to operate the atmospheric water generator. A sufficient energy production can be assessed if the energy output value is higher as the first threshold value. However, if, for example, the energy output value is defined to be negative, then a sufficient energy production can be assessed if the energy output value is lower than the first threshold. This may apply to all threshold values discussed in this specification.

If the energy output value is sufficient, in a further step 104, the energy management application electrically connects the solar cell layers of the solar glass components of the energy generation device to the energy storage and this to the atmospheric water generators.

In a further step 106, it is assessed whether the energy generation device generates excess energy that is not required for operating the atmospheric water generators. The energy output value is compared to a second threshold value. If the energy output value is higher than a second threshold value, the energy management application electrically connect or disconnect the solar cell layers to the energy storage devices. The excess energy may then be used to charge the energy storage devices.

In a further step 108, if the energy output value is lower than the first threshold value, the energy management device may electrically connect the energy storage device to the atmospheric water generator. The solar cell layers may still be electrically connected to energy storage device, such that both, the solar cell layers and the energy storage devices may power the atmospheric water generator.

Furthermore, the method 100 may comprise the optional steps 110 and 112. In step 110, the charge of the energy storage device is determined. The charge is represented by a charge value. If the charge value is higher than the third threshold value it means that the energy storage device is fully charged and cannot store more energy. If, furthermore, the energy generation device produces excess energy, then the energy management application may electrically connect the energy storage device with the output port in a further step 112.

The invention is not limited to one of the afore mentioned embodiments. It can be modified in many ways.

All features and advantages resulting from the claims, the description, and the drawing, including constructive details, spatial arrangements, and procedural steps, may be essential for the invention both in themselves and in various combinations.

### REFERENCE SIGNS

10 system for generating atmospheric water
12 energy generation device
14 atmospheric water generator
16 solar glass component
18 solar cell layer
20 energy storage device
22 energy management application
24 electrical line
26 electrical line
28 electrical line
30 electrical line
32 electrical line
34 support structure
36 diagonal strut
38 vertical bars
40 horizontal bar
42 floor
44 horizontal profile
46 horizontal profile
48 first end section
50 second end section
52 side surface
54 housing
56 level
58 level
60 level
62 level
64 level

1. A system for generating atmospheric water, the system comprising:
at least one energy generation device; and
at least one atmospheric water generator.
wherein the at least one energy generation device comprises at least one solar glass component having at least one solar cell layer, wherein the at least one solar cell layer is electrically connectable to the at least one atmospheric water generator.

2. The system according to claim 1, wherein the system further comprises at least one energy storage device, wherein the at least one solar cell layer is electrically connected to the energy storage device which is electrically connected to the at least one atmospheric water generator, wherein an energy consumption and/or distribution is controlled by at least one energy management application.

3. The system according to claim 2, wherein the at least one solar cell layer, the at least one atmospheric water generator and the at least one energy storage device are electrically connected to the energy management application.

4. The system according to claim 3, wherein the at least one energy management application is configured to electrically connect the at least one solar cell layer and/or to the at least one energy storage device to the at least one atmospheric water generator.

5. System The system according to claim 3, wherein the at least one energy management application is configured to electrically connect the at least one energy storage device to the at least one atmospheric water generator.

6. The system according to claim 1, wherein the system further comprises an energy output port.

7. The system according to claim 3, wherein the at least one energy management application is electrically connected to the energy output port and wherein the at least one energy management application is configured to connect the at least one solar cell layer to the energy output port.

8. The system according to claim 1, wherein the system comprises a housing with a skeleton support structure, wherein the skeleton support structure comprises at least one diagonal strut being connected to the skeleton support structure with a first end section and a second end section, the at least one diagonal strut having a flat side surface extending between the first end section and the second end section.

9. The system according to claim 8, wherein the at least one solar glass component is attached to the skeleton support structure, the at least one solar glass component forming a wall and/or a roof section of the housing.

10. The system according to claim 8, wherein the housing has a pyramid shape or a castle shape.

11. The system according to claim 1, wherein the system comprises a plurality of solar glass components.

12. A method for controlling the system according to claim 3, the method comprising:
determining an energy output value of the energy generation device;
connecting the at least one solar cell layer with the at least one energy storage device via the energy management application if the energy output value is higher than a first threshold value;
connecting the at least one solar cell layer with the at least one energy storage device via the energy management application if the energy output value is higher than a second threshold value; and
connecting the at least one energy storage device to the at least one atmospheric water generation device via the energy management application if the energy output value is below the first threshold value.

13. The method according to claim 12, wherein the method further comprises:
determining a charge value of the energy storage device; and
connecting the at least one solar cell layer with an energy output port via the energy management application if the charge value is higher than a third threshold value and if the energy output value is higher than the second threshold value.
